(19) United States
(12) Patent Application Publication
(10) Pub. No.: US 2025/0337098 A1
(43) Pub. Date: Oct. 30, 2025

(54) BATTERY PACK

(71) Applicants: Hyundai Motor Company, Seoul (KR); Kia Corporation, Seoul (KR)

(72) Inventors: Kyung Mo Kim, Hwaseong-si (KR); Jong Gyu Park, Hwaseong-si (KR); Gun Woo Ko, Hwaseong-si (KR); Chan Sol Kim, Hwaseong-si (KR)

(21) Appl. No.: 18/952,003

(22) Filed: Nov. 19, 2024

(30) Foreign Application Priority Data
Apr. 30, 2024 (KR) 10-2024-0057934

(51) Int. Cl. H01M 50/358; H01M 50/209

(52) U.S. Cl. CPC H01M 50/358; H01M 50/209

(57) ABSTRACT

An embodiment battery pack includes a battery housing and a battery cell stack accommodated in an interior of the battery housing. The battery cell stack includes battery cells extending in a first direction and arranged in a second direction crossing the first direction and a plate disposed between the battery cells, the plate including a venting guide part extending in the second direction on one side of the battery cells in a third direction crossing the first direction and the second direction of the battery cells.

### CROSS-REFERENCE TO RELATED APPLICATIONS

This application claims the benefit of Korean Patent Application No. 10-2024-0057934,filed on Apr. 30, 2024, which application is hereby incorporated herein by reference.

### TECHNICAL FIELD

The present disclosure relates to a battery pack.

### BACKGROUND

Recently, as awareness of the crisis regarding the environment and depletion of petroleum resources has increased, research and development on electric vehicles that are eco-friendly vehicles has been highlighted. Electric vehicles include a plug-in hybrid electric vehicle (PHEV), a battery electric vehicle (BEV), and a fuel cell electric vehicle (FCEV).

An electric vehicle may include a battery housing that supports battery cells. Meanwhile, an electric vehicle uses battery cells as a power source, and efforts have been made recently to increase the capacity of battery cells accommodated in an interior of the battery housing.

To improve the capacity of battery cells, battery cells may be accommodated in the interior of the battery housing in the form of cell to pack (CTP) rather than in the form of modules. Meanwhile, a venting path for venting high-temperature gases or flames generated from the battery cells may be required in an interior of the battery housing. Accordingly, a need for a battery pack that has a CTP form and forms a venting path is increasing.

### SUMMARY

Embodiments of the present disclosure can solve problems occurring in the prior art while advantages achieved by the prior art are maintained intact.

An embodiment of the present disclosure provides a battery pack that defines a venting passage while battery cells are accommodated in a CTP form.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery pack includes a battery housing and a battery cell stack accommodated in an interior of the battery housing. The battery cell stack includes battery cells extending in a first direction, and arranged in a second direction crossing the first direction, and a plate disposed between the battery cells and having a venting guide part extending in the second direction on one side of the battery cells in a third direction crossing the first direction and the second direction of the battery cells.

A pair of venting guide parts are spaced apart from each other in the first direction in parallel, and the pair of venting guide parts may define a venting passage located between the pair of venting guide parts.

The battery pack may further include a pack cover coupled to the battery housing to cover the one side of the battery cells in the third direction, and the pack cover may contact the pair of venting guide parts to define the venting passage together with the pair of venting guide parts.

The battery pack may further include a venting sheet disposed between the pair of venting guide parts and having a perforated part including a plurality of cutaway areas disposed along a periphery of an area facing the battery cells to be spaced apart from each other or a notch part having a thickness that is smaller than a thickness of the periphery.

The battery pack may further include a venting frame including a communication hole disposed on one side of the venting sheet in the third direction and formed on an area facing the perforated part or the notch part.

A plurality of plates may be arranged in the second direction, and some of the plurality of plates may be configured such that the venting guide parts of two adjacent plates contact each other in the second direction.

The venting guide parts of the two plates, that contact each other in the second direction, may be configured to be coupled to each other.

The venting guide part may further include a venting guide wall extending in the second direction and configured to have a predetermined height in the third direction, and the venting guide wall may include a coupling protrusion disposed on a one side area in the second direction and a coupling hole disposed on an opposite side area in the second direction.

The battery pack may further include a pack cover coupled to the battery housing to cover the one side of the battery cells in the third direction, and the venting guide part may further include a cover support wall extending in the first direction from one end of the venting guide wall in the third direction and contacting the pack cover.

A pair of venting guide parts may be spaced apart from each other in parallel in the first direction to define a venting passage therebetween, and the cover support wall may be bent from the venting guide wall in an opposite direction to the venting passage.

The venting guide part may further include a cell support wall extending in the first direction from an opposite end of the venting guide wall in the third direction and contacting the battery cells.

A pair of venting guide parts may be spaced apart from each other in parallel in the first direction to define a venting passage therebetween, and the cell support wall may be bent from the venting guide wall in an opposite direction to the venting passage.

The battery cell stack may include a first battery cell stack and a second battery cell stack spaced apart from the first battery cell stack to one side in the second direction, and the plate may include a plurality of first plates disposed in the first battery cell stack and arranged in the second direction, each including a first venting guide part extending to the one side in the second direction, a plurality of second plates disposed in the second battery cell stack and arranged in the second direction, each including a second venting guide part extending to an opposite side in the second direction, and a connecting bracket connecting, among the plurality of first plates, a first plate disposed on the one side most in the second direction and, among the plurality of second plates, a second plate disposed on the opposite side most in the second direction and covering an area between the first battery cell stack and the second battery cell stack.

The first venting guide part may include a coupling protrusion formed on one side area in the second direction, the second venting guide part may include a coupling protrusion disposed on an opposite side area in the second direction, and the connecting bracket may include a first connection hole disposed on one side area in the second direction such that the coupling protrusion of the first venting guide part is insertable thereinto and a second connection hole disposed on an opposite side area in the second direction such that the coupling protrusion of the second venting guide part is insertable thereinto.

A pair of second venting guide parts may be spaced apart from each other in parallel in the first direction to define a venting passage therebetween, and the battery pack may further include a venting device disposed on one side area of the battery housing in the second direction and disposed on an opposite side of the venting passage in the third direction and an end bracket coupled to the second venting guide part of a second plate, among the plurality of second plates, disposed on the one side most in the second direction and bent to an opposite side in the third direction to define a space communicating the venting passage and an interior space of the venting device.

The venting guide part of a second plate, among the plurality of second plates, disposed on the one side most in the second direction may include a coupling hole formed on one side area in the second direction, and the end bracket may include an end protrusion disposed on an opposite side area in the second direction to be inserted into the coupling hole.

A pair of first venting guide parts may be spaced apart from each other in parallel in the first direction to define a venting passage therebetween, and the battery pack may further include a cover bracket coupled to the first venting guide part of a first plate, among the plurality of first plates, disposed on the opposite side most in the second direction and covering an opposite side area of the venting passage in the second direction.

The venting guide part of a first plate, among the plurality of first plates, disposed on the opposite side most in the second direction, may include a coupling hole disposed on the opposite side area in the second direction, and the cover bracket may include a cover protrusion disposed on one side area in the second direction to be inserted into the coupling hole.

The plate may further include a cooling part disposed between the battery cells on an opposite side of the venting guide part in the third direction and contacting the battery cells, the cooling part may comprise aluminum, and the venting guide part may comprise steel.

According to another embodiment of the present disclosure, a battery pack includes a battery housing, a battery cell stack accommodated in an interior of the battery housing, and a pack cover contacting the battery housing to cover the battery cell stack. The battery cell stack includes battery cells extending in a first direction and arranged in a second direction crossing the first direction and a venting guide part extending in the second direction to define a venting passage extending in the second direction between the battery cells and the pack cover, and disposed at one side of the venting passage in the first direction.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a rear perspective view of a battery pack according to an embodiment of the present disclosure;

FIG. 2 is an exploded perspective view of a battery pack according to an embodiment of the present disclosure;

FIG. 3 is a rear perspective view of a battery cell stack and a battery housing according to an embodiment of the present disclosure;

FIG. 4 is an enlarged view of part “A” illustrated in FIG. 3;

FIG. 5 is an enlarged view of part “B” illustrated in FIG. 3;

FIG. 6 is an enlarged view of part “C” illustrated in FIG. 3;

FIG. 7 is an enlarged view of part “D” illustrated in FIG. 3;

FIG. 8 is a perspective view of a plate according to an embodiment of the present disclosure;

FIG. 9 is a perspective view of a first plate, a second plate, a cover bracket, a connecting bracket, and an end bracket according to an embodiment of the present disclosure;

FIG. 10 is a vertical cross-sectional view of a battery pack according to an embodiment of the present disclosure;

FIG. 11 is a vertical cross-sectional view of a battery pack according to an embodiment of the present disclosure;

FIG. 12 is a cross-sectional view of a venting guide part, a battery cell, and a pack cover according to an embodiment of the present disclosure; and

FIG. 13 is a perspective view of a plate according to another embodiment of the present disclosure.

### DETAILED DESCRIPTION OF ILLUSTRATIVE EMBODIMENTS

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms such as first, second, “A,” “B,” (a), and (b) may be used. The terms are simply for distinguishing the components, and the essence, the sequence, and the order of the corresponding components are not limited by the terms. Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

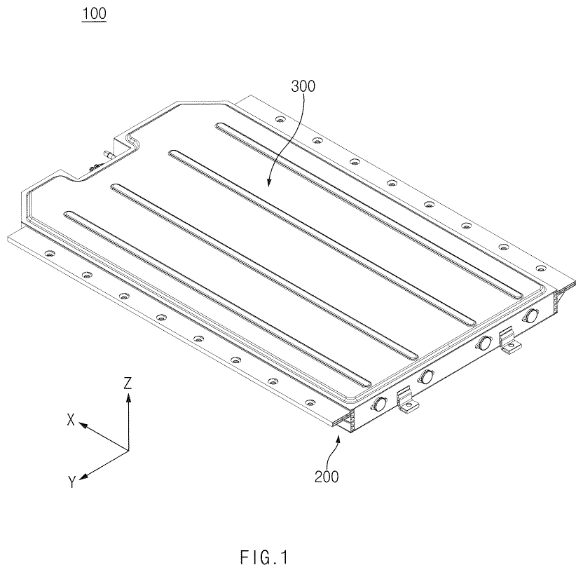

Hereinafter, embodiments of the present disclosure will be described in detail with reference to FIGS. 1 to 13. Hereinafter, a leftward/rightward direction may be a first direction, a forward/rearward direction may be a second direction, and an upward/downward direction may be a third direction.

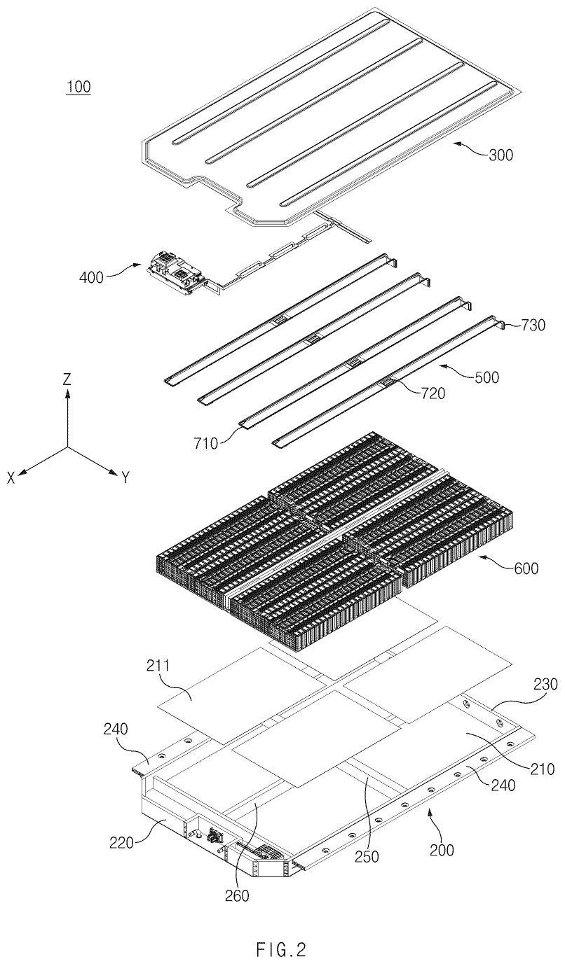

FIG. 1 is a rear perspective view of a battery pack according to an embodiment of the present disclosure. FIG. 2 is an exploded perspective view of a battery pack according to an embodiment of the present disclosure.

Referring to FIGS. 1 and 2, a battery pack 100 may include a battery housing 200 and a pack cover 300 that is disposed at an upper side (the “Z” direction) of the battery housing 200. The battery pack 100 may include a battery cell stack 600 that is accommodated in an interior of the battery housing 200. The pack cover 300 may be coupled to or contact the battery housing 200 to cover an upper side of the battery cell stack 600.

The battery pack 100 may include an electrical part module 400 that is configured to control the battery cell stack 600 and a venting module 500 that is disposed on an upper side of the battery cell stack 600. A cover bracket 710 may be provided in a front area of the venting module 500, a connecting bracket 720 may be provided in a central area of a forward/rearward direction of the venting module 500, and an end bracket 730 may be provided in a rear area of the venting module 500.

The battery housing 200 may define a space in which the battery cell stack 600 is accommodated. The battery housing 200 may include a base plate 210 that supports the battery cell stack 600, a front member 220 that is supported by the base plate 210 and covers a front (the “X” direction) area of the battery cell stack 600, and a rear member 230 that covers a rear (an opposite direction to the “X” direction) area of the battery cell stack 600.

The battery housing 200 may include side members 240 that are disposed on opposite sides of the base plate 210 in the leftward/rightward direction and are supported by the base plate 210. A pair of side members 240 may be provided on opposite sides of the battery cell stack 600 in the leftward/rightward direction, respectively. The pair of side members 240 may cover opposite areas of the battery cell stack 600 in the leftward/rightward direction, respectively.

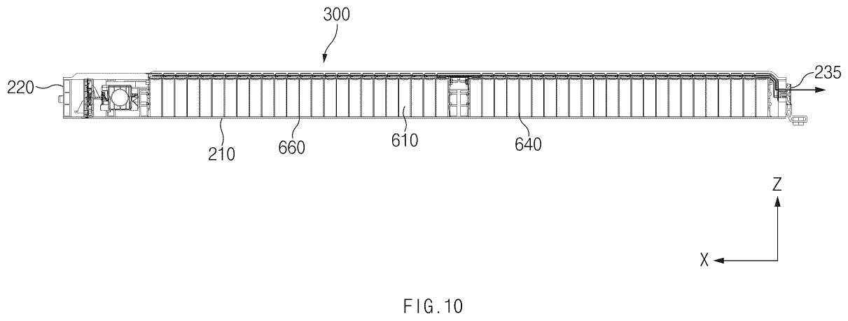

The battery cell stack 600 may include a plurality of battery cells 610 (see FIG. 10). The battery cells 610 may extend in the leftward/rightward direction and may be arranged in a forward/rearward direction. The battery cells 610 may be angular lithium ion batteries, but are not limited thereto. The plurality of battery cells 610 may be accommodated in the battery housing 200 with no separate module frame.

That is, the battery cells 610 according to embodiments of the present disclosure may be mounted in an interior of the battery pack 100 in the form of a cell-to-pack (CTP). However, a method in which the battery cells 610 are mounted on the battery pack 100 is not limited thereto, and the battery cells 610 may be provided with a separate module frame to be accommodated in an interior of the battery housing 200.

The battery housing 200 may include a transverse crossing member 250 that is disposed between the front member 220 and the rear member 230. The transverse crossing member 250 may extend in the leftward/rightward direction (the “Y” direction or an opposite direction to the “Y” direction) between the front member 220 and the rear member 230. The transverse crossing member 250 may support a pair of battery cell stacks 600 that are disposed between a plurality of battery cell stacks 600 and are disposed parallel to each other with the transverse crossing members 250 being interposed therebetween.

The battery housing 200 may include a longitudinal crossing member 260 that extends from the rear member 230 toward the front member 220 between the pair of side members 240. The longitudinal crossing member 260 may be disposed between the pair of transverse crossing members 250 that are provided to be spaced apart from each other in the leftward/rightward direction.

A heat dissipating adhesive 211 may be provided on an area of the base plate 210, which is divided by the transverse crossing member 250 and the longitudinal crossing member 260.

A plurality of battery cell stacks 600 may be provided to be mounted on areas that are divided by the transverse crossing member 250 and the longitudinal crossing member 260, respectively. The battery cell stacks 600 may be spaced apart from each other in the forward/rearward direction with the transverse crossing member 250 being interposed therebetween.

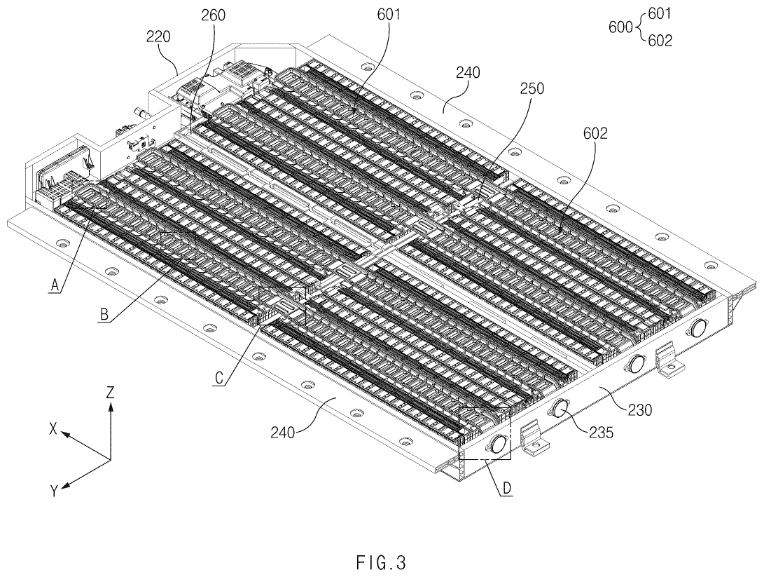

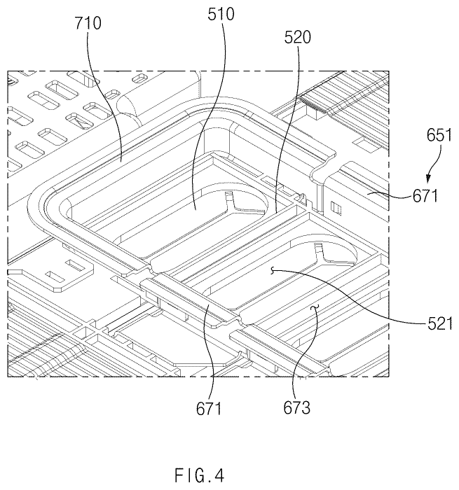

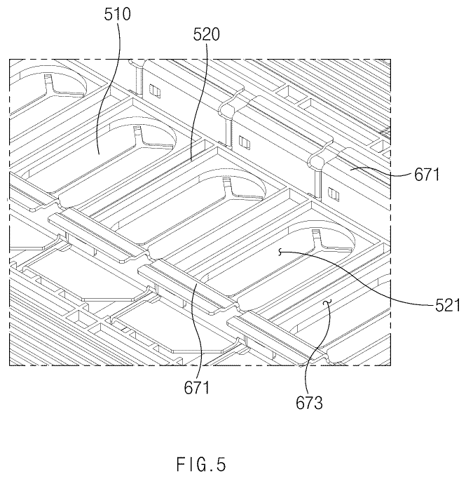

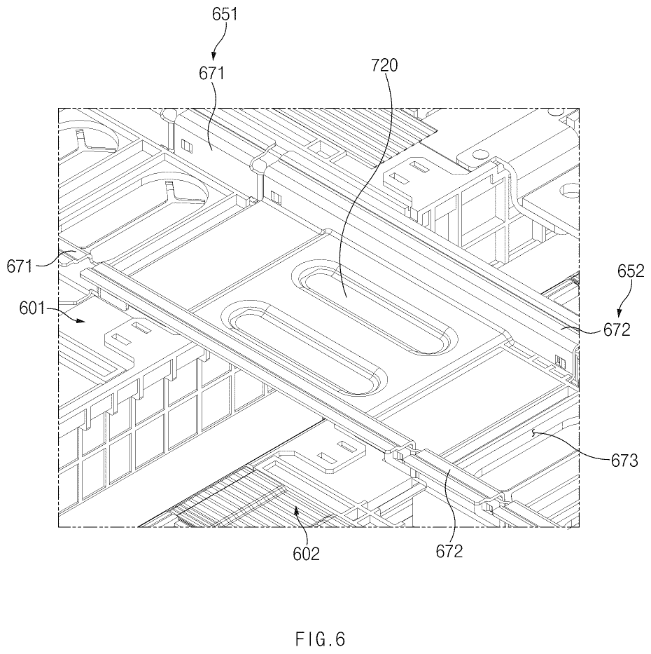

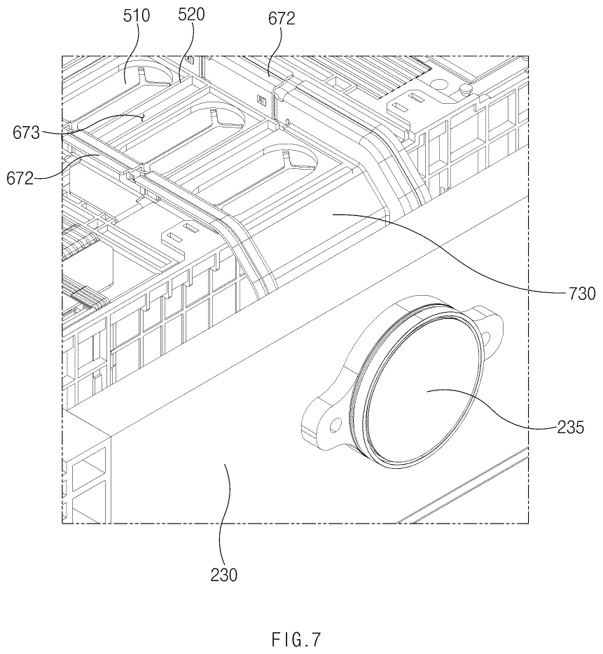

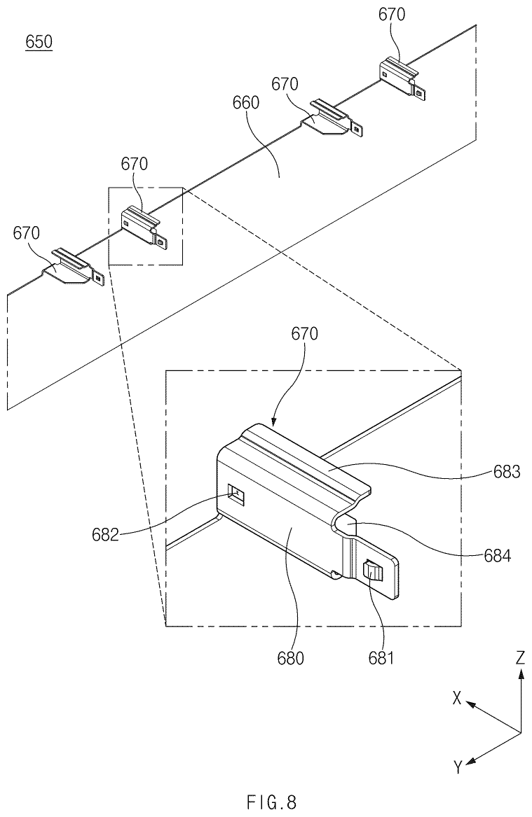

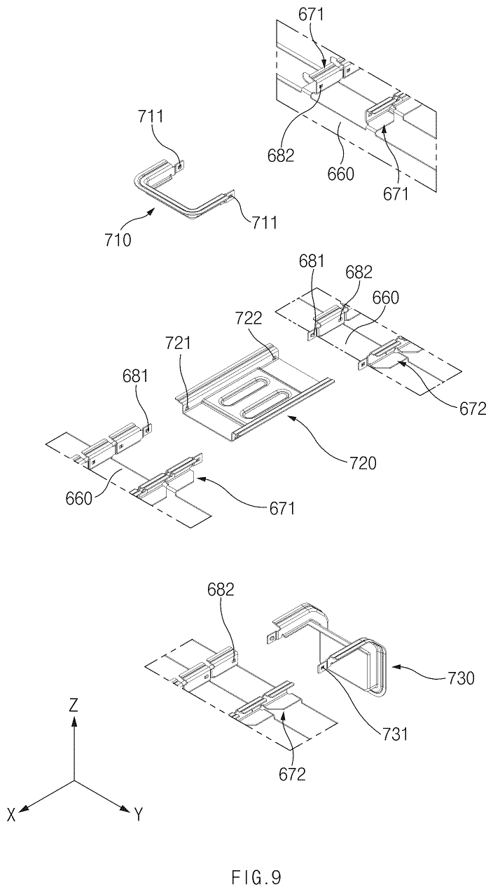

FIG. 3 is a rear perspective view of a battery cell stack and a battery housing according to an embodiment of the present disclosure. FIG. 4 is an enlarged view of part “A” illustrated in FIG. 3. FIG. 5 is an enlarged view of part “B” illustrated in FIG. 3. FIG. 6 is an enlarged view of part “C” illustrated in FIG. 3. FIG. 7 is an enlarged view of part “D” illustrated in FIG. 3. FIG. 8 is a perspective view of a plate according to an embodiment of the present disclosure. FIG. 9 is a perspective view of a first plate, a second plate, a cover bracket, a connecting bracket, and an end bracket according to an embodiment of the present disclosure. FIG. 10 is a vertical cross-sectional view of a battery pack according to an embodiment of the present disclosure.

Referring to FIGS. 3 to 10, the battery cell stack 600 may include first and second battery cell stacks 601 and 602. The second battery cell stack 602 may be spaced apart from the first battery cell stack 601 to a rear side that is one side in the first direction.

A venting passage 673 for venting high temperature gas or flames generated in the battery cell 610 to an outside of the battery pack 100 when a fire occurs in the battery cell stack 600 may be provided on an upper side of the battery cell stack 600. At least one venting passage 673 may be provided between opposite side ends of the battery cell stack 600 in the leftward/rightward direction. The venting passage 673 may extend in the forward/rearward direction, and a venting device 235 may be provided on a rear side of the venting passage 673.

The venting device 235 may be formed to correspond to the number of the venting passages 673 in the rear member 230. The venting device 235 may not communicate the venting passages 673 with an outside of the battery pack 100 when the battery cell 610 is operated normally, but may be configured to communicate the venting passages 673 with the outside of the battery pack 100 as a fire occurs in the battery cell 610.

As illustrated in FIG. 8, the battery cell stack 600 may include a surface-pressure member 640 (see FIG. 10) and a plate 650 that are disposed between the battery cells 610. The plate 650 may include a cooling part 660 that is disposed between the battery cells 610 and a venting guide part 670 that protrudes upward from the cooling part 660 and extends in the forward/rearward direction from the upper side of the battery cells 610.

The venting guide part 670 may be bent upward from the cooling part 660 and extend forward or rearward. The venting guide parts 670 may be configured to be spaced apart from each other in parallel in the leftward/rightward direction, and a venting passage 673 may be formed between the pair of venting guide parts 670.

That is, the pair of venting guide parts 670 may be disposed on opposite sides of the venting passage 673 in the leftward/rightward direction. This may be for the venting guide part 670 to extend in the forward/rearward direction on opposite sides of the venting passage 673 in the leftward/rightward direction so that the venting passage 673 extends in the forward/rearward direction.

The venting guide part 670 may include a venting guide wall 680 that extends in the forward/rearward direction and is configured to have a specific height in an upward/downward direction. The venting guide wall 680 may include a coupling protrusion 681 and a coupling hole 682. The coupling protrusion 681 and the coupling hole 682 may be formed on opposite areas of the venting guide wall 680.

The venting passage 673 may be defined by a pair of venting guide walls 680 in the leftward/rightward direction and may be defined by the pack cover 300 and the battery cell stack 600 or the connecting bracket 720 in the upward/downward direction.

The venting guide part 670 may contact the pack cover 300 and the battery cell stack 600. That is, the pack cover 300 may contact the pair of venting guide parts 670 to define a venting passage 673 together with the pair of venting guide parts 670.

The venting guide part 670 may include a cover support wall 683 that extends in the leftward/rightward direction from an upper end of the venting guide wall 680. The cover support wall 683 may contact the pack cover 300. The cover support wall 683 may be bent from the venting guide wall 680 in an opposite direction to the venting passage 673.

The venting guide part 670 may include a cell support wall 684 that extends in the leftward/rightward direction from a lower end of the venting guide wall 680. The cell support wall 684 may contact the battery cells 610. The cell support wall 684 may be bent from the venting guide wall 680 in an opposite direction to the venting passage 673.

Referring back to FIGS. 3 to 7, the plate 650 may include a plurality of first plates 651 that are provided in the first battery cell stack 601, each of which includes a first venting guide part 671 that extends rearward, and that are arranged in the forward/rearward direction, and a plurality of second plates 652 that are provided in the second battery cell stack 602, each of which includes a second venting guide part 672 that extends forward, and that are arranged in the forward/rearward direction.

A plurality of first plates 651 may be provided to be arranged in the forward/rearward direction, and the first venting guide parts 671 of two adjacent first plates 651, among the plurality of first plates 651, may be provided to contact each other in the forward/rearward direction. In more detail, the plurality of first venting guide parts 671 may be configured to be coupled to each other in the forward/rearward direction.

Similarly, a plurality of second plates 652 may be provided to be arranged in the forward/rearward direction, and the second venting guide parts 672 of two adjacent second plates 652, among the plurality of second plates 652, may be provided to contact each other in the forward/rearward direction. In more detail, the plurality of second venting guide parts 672 may be configured to be coupled to each other in the forward/rearward direction.

A first venting guide part 671 of the first plate 651 disposed on the foremost side, among a plurality of first plates 651, may be coupled to the cover bracket 710. The cover bracket 710 may be configured to cover a front area of the venting passage 673 that extends in the forward/rearward direction. Due to the cover bracket 710, high temperature gas or a flame that flows in the venting passage 673 may be prevented from flowing to a front side of the first battery cell stack 601.

Meanwhile, the venting passage 673 needs to extend between the first battery cell stack 601 and the second battery cell stack 602. To this end, the connecting bracket 720 may cover an upper area of an area between the first battery cell stack 601 and the second battery cell stack 602.

The connecting bracket 720 may connect the first plate 651 disposed on the rearmost side of the plurality of first plates 651 and the second plate 652 disposed on the foremost side of the plurality of second plates 652.

Among a plurality of second plates 652, the second plate 652 disposed on the rearmost side may be coupled to the end bracket 730. The end bracket 730 may be coupled to the second venting guide part 672 of the second plate 652 disposed on the rearmost side, among the plurality of second plates 652, and may be bent downward toward the rear side.

The end bracket 730 may define a space for communicating the venting passage 673 and the interior space of the venting device 235, and for this purpose, may cover a rear area of the second battery cell stack 602.

Furthermore, because the venting device 235 is mounted on the rear member 230 and is disposed on a lower side of the venting passage 673, the end bracket 730 may guide the high-temperature gas or flame that flows through the venting passage 673 toward the venting device 235.

Referring to FIG. 9, a venting guide wall 680 (see FIG. 8) of the first venting guide part 671 may extend backward. The coupling protrusion 681 of the first venting guide part 671 may be formed on a rear area of the venting guide wall 680, and the coupling hole 682 of the first venting guide part 671 may be formed on a front area of the venting guide wall 680.

According to this structure, the coupling protrusion 681 of the first venting guide part 671 located on a front side of the plurality of first venting guide parts 671 may be inserted into the coupling hole 682 of the first venting guide part 671 located on a rear side.

Furthermore, the first venting guide part 671 disposed on the foremost side, among the plurality of first venting guide parts 671, may include a coupling hole 682 that is formed on a front area. The cover bracket 710 may include a cover protrusion 711 that is to be inserted into the coupling hole 682 of the first venting guide part 671 disposed on the foremost side of the plurality of first venting guide parts 671.

The cover protrusion 711 may be formed on a rear area of the cover bracket 710. A pair of cover protrusions 711 may be provided to be spaced apart from each other in the leftward/rightward direction such that the cover bracket 710 is coupled to both of the pair of first venting guide parts 671.

The venting guide wall 680 of the second venting guide part 672 may extend forward. The coupling protrusion 681 of the second venting guide part 672 may be formed on a front area of the venting guide wall 680, and the coupling hole 682 of the second venting guide part 672 may be formed on a rear area of the venting guide wall 680.

According to this structure, the coupling protrusion 681 of the second venting guide part 672 located on a rear side may be inserted into the coupling hole 682 of the second venting guide part 672 located on a front side, among the plurality of second venting guide parts 672.

A first venting guide part 671 disposed on the rearmost side, among the plurality of first venting guide parts 671, and a second venting guide part 672 disposed on the foremost side, among the plurality of second venting guide parts 672, may extend toward each other.

A first venting guide part 671 disposed on the rearmost side, among the plurality of first venting guide parts 671, and a second venting guide part 672 disposed on the foremost side, among the plurality of second venting guide parts 672, may be coupled to the connecting bracket 720.

The connecting bracket 720 may connect the first venting guide part 671 disposed on the rearmost side, among the plurality of first venting guide parts 671, and the second venting guide part 672 disposed on the foremost side, among the plurality of second venting guide parts 672.

The coupling protrusion 681 of the first venting guide part 671 disposed on the rearmost side, among the plurality of first venting guide parts 671, may be formed on a rear area toward the connecting bracket 720, and the coupling protrusion 681 of the second venting guide part 672 disposed on the foremost side, among the plurality of second venting guide parts 672, may be formed on a front area toward the connecting bracket 720.

The connecting bracket 720 may include a first connection hole 721 formed on a front area, and for inserting the coupling protrusion 681 of the first venting guide part 671 disposed on the rearmost side, among the plurality of first venting guide parts 671, and a second connection hole 722 formed on a rear side, and for inserting the coupling protrusion 681 of the second venting guide part 672 disposed on the foremost side, among the plurality of second venting guide parts 672.

The second venting guide part 672 disposed on the rearmost side, among the plurality of second venting guide parts 672, may include a coupling hole 682 that is formed on a rear area. The end bracket 730 may include an end protrusion 731 that is formed on a front area and is inserted into the coupling hole 682 of the second venting guide part 672 disposed on the rearmost side, among the plurality of second venting guide parts 672.

According to the above-described structure, the first venting guide parts 671 of adjacent first plates 651 may be coupled to each other, and the first venting guide part 671 of the first plate 651 disposed on the foremost side, among the plurality of first plates 651, may be coupled to the cover bracket 710.

Furthermore, the second venting guide parts 672 of adjacent second plates 652 may be coupled to each other, and the second venting guide part 672 of the second plate 652 disposed on the rearmost side, among the plurality of second plates 652, may be coupled to the end bracket 730.

Furthermore, the first venting guide part 671 of the first plate 651 disposed on the rearmost side, among the plurality of first plates 651, and the second venting guide part 672 of the second plate 652 disposed on the foremost side, among the plurality of first plates 651, may be coupled to the connecting bracket 720.

Meanwhile, as illustrated in FIG. 4, the venting module 500 (see FIG. 1) may be provided between the battery cell 610 and the venting guide part 670. The venting module 500 may include a venting sheet 510 that is disposed between the pair of venting guide parts 670 that are spaced apart from each other in the leftward/rightward direction on an upper side of the battery cell 610 and a venting frame 520 that supports the venting sheet 510 on an upper side of the venting sheet 510.

The venting sheet 510 may have a perforated part including a plurality of cutaway areas that are spaced apart from each other along a periphery of an area that faces the battery cell 610 or a notch part having a smaller thickness than a periphery thereof.

However, the venting sheet 510 is not limited thereto, and it may have a shape of a slit that extends in the leftward/rightward direction on an area that faces the battery cell 610. The venting sheet 510 may be a component for guiding a high temperature gas or flame generated in the battery cell 610 to the venting passage 673 when a fire occurs in the battery cell 610.

The venting frame 520 may include a communication hole 521 that is formed on an area that faces the perforated part, the notch part, or the slit. The communication hole 521 may be a component for communicating the battery cell 610, in which the fire occurs, and the venting passage 673 when the fire occurs in the battery cell 610.

In this way, the perforated part, the notch part, or the slit may be formed between opposite ends of the battery cell 610 in the leftward/rightward direction, and at the same time, may be formed between the pair of guide parts 670 spaced apart from each other in the leftward/rightward direction. According to this structure, it is possible to prevent a high-temperature gas or flame that is generated in the battery cell 610 and flows into the venting passage 673 from flowing into another battery cell 610.

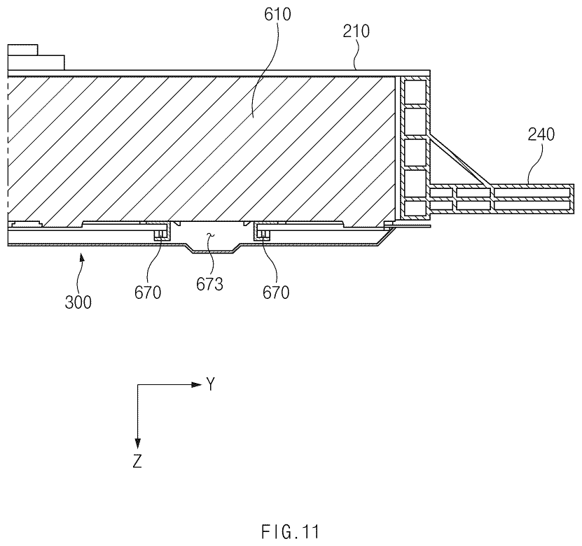

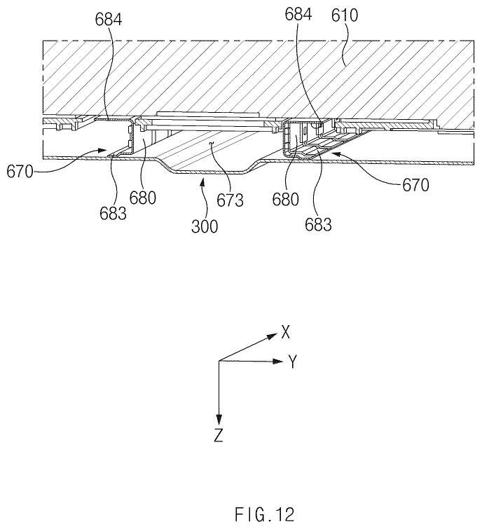

FIG. 11 is a vertical cross-sectional view of a battery pack according to an embodiment of the present disclosure. FIG. 12 is a cross-sectional view of a venting guide part, a battery cell, and a pack cover according to an embodiment of the present disclosure.

Referring to FIGS. 11 and 12, a battery pack 100 (see FIG. 1) may be mounted on the electric vehicle in a state in which the upward/downward direction is inverted. That is, the battery pack 100 may be mounted on the electric vehicle such that the pack cover 300 faces a road surface.

The pack cover 300 may be provided between the battery cell 610 and the road surface, and the base plate 210 may be provided between the battery cell 610 and a seating space, in which the user is seated. A cooling channel provided to cool the battery cell 610 may be formed in an interior of the base plate 210.

According to this structure, when a fire occurs in the battery cell 610, a high-temperature gas or flame flows into the venting passage 673 that is adjacent to the road surface, and thus, the safety of the user may be improved. Furthermore, the base plate 210 having a more improved strength than the pack cover 300 may be disposed adjacent to the user, so that the durability of the battery pack 100 may be improved, and damage to the battery cell 610 may be prevented.

On the other hand, according to a structure in which the battery pack 100 is mounted on an electric vehicle in a vertically inverted state, the cell support wall 684 may support the battery cell 610, and the cover support wall 683 may contact the pack cover 300.

In this way, according to the structure in which the venting guide part 670 supports the battery cell 610, the battery cell 610 may be spaced apart from the pack cover 300 in an upward/downward direction. This may be for preventing the impact applied to the pack cover 300 from being directly transmitted to the battery cell 610 or for transmitting the impact to other components of the battery pack 100 through the venting guide part 670 or the like when an obstacle that is adjacent to the road surface applies the impact to the pack cover 300.

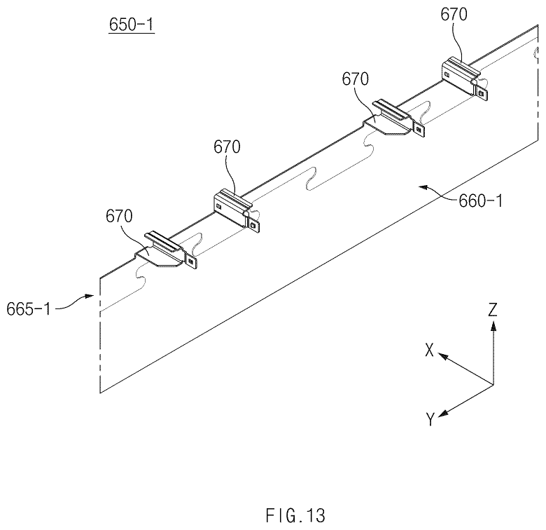

FIG. 13 is a perspective view of a plate according to another embodiment of the present disclosure.

Referring to FIG. 13, unlike the plate 650 illustrated in FIG. 8, in the plate 650-1, the venting part 665-1 including the venting guide part 670 and the cooling part 660-1 may be formed of different materials.

Here, the venting part 665-1 may be a part that is disposed on an upper side of the cooling part 660-1 and is coupled to the cooling part 660-1. The venting part 665-1 may be a part which high-temperature gas, flame, or the like that flows in the venting passage 673 (see FIG. 4) contacts.

That is, the cooling part 660-1 may be formed of aluminum for cooling the battery cell 610 (see FIG. 11), and the venting part 665-1 including the venting guide part 670 may be formed of steel to improve durability against high-temperature gas or flame. Without being limited thereto, the venting guide part 670 may be formed of a material having a higher melting point than that of the cooling part 660-1. This may be because the venting guide part 670 may contact high-temperature gas or flame, and thus, a stronger durability than that of the cooling part 660-1 is required.

According to this structure, the battery cell 610 may be cooled more efficiently than the cooling part 660 of FIG. 8, and the durability may be improved compared to the venting guide part 670 of FIG. 8.

The present technology may improve a capacity of the battery cells that are accommodated in the battery pack and prevent a thermal runaway phenomenon because the battery cells are accommodated in the battery housing in a form of a stack instead of a separate module and the venting passage is formed in an interior of the battery pack.

In addition, the present technology may prevent a thermal runaway phenomenon of the battery pack because the venting guide part of the plate may guide the flow direction of a high-temperature gas or flame that flows through the venting passage.

Furthermore, the present technology may improve the safety of the battery pack because the battery cells may be spaced apart from the pack cover in a state where the battery pack is inverted upside down.

In addition, various effects that may be directly or indirectly identified through this document may be provided.

The above description is a simple exemplary description of the technical spirits of the present disclosure, and a person of ordinary skill in the art to which the present disclosure pertains may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a battery housing; and
a battery cell stack accommodated in an interior of the battery housing, wherein the battery cell stack comprises:
battery cells extending in a first direction and arranged in a second direction crossing the first direction; and
a plate disposed between the battery cells, the plate comprising a venting guide part extending in the second direction on one side of the battery cells in a third direction crossing the first direction and the second direction of the battery cells.

2. The battery pack of claim 1, wherein:
a pair of venting guide parts are spaced apart from each other in the first direction in parallel; and
the pair of venting guide parts define a venting passage located between the pair of venting guide parts.

3. The battery pack of claim 2, further comprising a pack cover coupled to the battery housing to cover the one side of the battery cells in the third direction, wherein the pack cover contacts the pair of venting guide parts to define the venting passage together with the pair of venting guide parts.

4. The battery pack of claim 2, further comprising a venting sheet disposed between the pair of venting guide parts, the venting sheet comprising:
a perforated part comprising a plurality of cutaway areas disposed along a periphery of an area facing the battery cells to be spaced apart from each other; or
a notch part having a thickness that is smaller than a thickness of the periphery.

5. The battery pack of claim 4, further comprising a venting frame comprising a communication hole disposed on one side of the venting sheet in the third direction and disposed on an area facing the perforated part or the notch part.

6. The battery pack of claim 1, wherein a plurality of plates are arranged in the second direction, and wherein some of the plurality of plates are configured such that the venting guide parts of two adjacent plates contact each other in the second direction.

7. The battery pack of claim 6, wherein the venting guide parts of the two plates that contact each other in the second direction are configured to be coupled to each other.

8. The battery pack of claim 1, wherein:
the venting guide part further comprises a venting guide wall extending in the second direction and having a predetermined height in the third direction; and
the venting guide wall comprises a coupling protrusion disposed on one side area in the second direction and a coupling hole disposed on an opposite side area in the second direction.

9. The battery pack of claim 8, further comprising a pack cover coupled to the battery housing to cover the one side of the battery cells in the third direction, wherein the venting guide part further comprises a cover support wall extending in the first direction from one end of the venting guide wall in the third direction and contacting the pack cover.

10. The battery pack of claim 9, wherein:
a pair of venting guide parts are spaced apart from each other in parallel in the first direction to define a venting passage therebetween; and
the cover support wall is bent from the venting guide wall in an opposite direction to the venting passage.

11. The battery pack of claim 9, wherein the venting guide part further comprises a cell support wall extending in the first direction from an opposite end of the venting guide wall in the third direction and contacting the battery cells.

12. The battery pack of claim 11, wherein:
a pair of venting guide parts are spaced apart from each other in parallel in the first direction to define a venting passage therebetween; and
the cell support wall is bent from the venting guide wall in an opposite direction to the venting passage.

13. The battery pack of claim 1, wherein:
the battery cell stack comprises a first battery cell stack and a second battery cell stack spaced apart from the first battery cell stack to one side in the second direction; and
the plate comprises:
a plurality of first plates disposed in the first battery cell stack and arranged in the second direction, each including a first venting guide part extending to the one side in the second direction;
a plurality of second plates disposed in the second battery cell stack and arranged in the second direction, each including a second venting guide part extending to an opposite side in the second direction; and
a connecting bracket connecting, among the plurality of first plates, a first plate disposed on the one side most in the second direction and, among the plurality of second plates, a second plate disposed on the opposite side most in the second direction, the connecting bracket covering an area between the first battery cell stack and the second battery cell stack.

14. The battery pack of claim 13, wherein:
the first venting guide part comprises a coupling protrusion disposed on one side area in the second direction;
the second venting guide part comprises a coupling protrusion disposed on an opposite side area in the second direction; and
the connecting bracket comprises:
a first connection hole disposed on one side area in the second direction such that the coupling protrusion of the first venting guide part is insertable thereinto; and
a second connection hole disposed on an opposite side area in the second direction such that the coupling protrusion of the second venting guide part is insertable thereinto.

15. The battery pack of claim 13, wherein:
a pair of second venting guide parts are spaced apart from each other in parallel in the first direction to define a venting passage therebetween; and
the battery pack further comprises:
a venting device disposed on one side area of the battery housing in the second direction and disposed on an opposite side of the venting passage in the third direction; and
an end bracket coupled to the second venting guide part of a second plate, among the plurality of second plates, disposed on the one side most in the second direction and bent to an opposite side in the third direction to define a space communicating the venting passage and an interior space of the venting device.

16. The battery pack of claim 15, wherein:
the venting guide part of a second plate, among the plurality of second plates, disposed on the one side most in the second direction comprises a coupling hole disposed on one side area in the second direction; and
the end bracket comprises an end protrusion disposed on an opposite side area in the second direction to be inserted into the coupling hole.

17. The battery pack of claim 13, wherein:
a pair of first venting guide parts are spaced apart from each other in parallel in the first direction to define a venting passage therebetween; and
the battery pack further comprises a cover bracket coupled to the first venting guide part of a first plate, among the plurality of first plates, disposed on the opposite side most in the second direction and covering an opposite side area of the venting passage in the second direction.

18. The battery pack of claim 17, wherein:
the venting guide part of a first plate, among the plurality of first plates, disposed on the opposite side most in the second direction comprises a coupling hole disposed on the opposite side area in the second direction; and
the cover bracket comprises a cover protrusion disposed on one side area in the second direction to be inserted into the coupling hole.

19. The battery pack of claim 1, wherein the plate further comprises a cooling part disposed between the battery cells on an opposite side of the venting guide part in the third direction and contacting the battery cells, wherein the cooling part comprises aluminum, and wherein the venting guide part comprises steel.

20. A battery pack comprising:
a battery housing;
a battery cell stack accommodated in an interior of the battery housing; and
a pack cover contacting the battery housing to cover the battery cell stack; and
wherein the battery cell stack comprises:
battery cells extending in a first direction and arranged in a second direction crossing the first direction; and
a venting guide part extending in the second direction to define a venting passage extending in the second direction between the battery cells and the pack cover, and disposed at one side of the venting passage in the first direction.
